(19) United States
(12) Patent Application Publication
(10) Pub. No.: US 2009/0272238 A1
(43) Pub. Date: Nov. 5, 2009

(54) SCREW DRIVER

(76) Inventor: David Harris, Burson, CA (US)

Correspondence Address: PENINSULA IP GROUP, 26150 BUCKS RUN, CORRAL DE TIERRA, CA, 93908, US

(21) Appl. No.: 12/113,166

(22) Filed: Apr. 30, 2008

(51) Int. Cl. B25B 15/02

(52) U.S. Cl. 81/437

(57) ABSTRACT

Disclosed herein is a structure for an improved screw driver having a torquing member. The screw driver having a handle end and a working end. The working end is adapted to turn screws. The handle end having openings adapted to receive the torquing member. The opening being generally perpendicular to the longitudinal axis. In one embodiment, the torquing member has an elongated member extending from the handle through the opening and having a second end. A secondary handle member is attached to the second end for assisting to apply torque to the screw driver while turning screws.

### FIELD OF THE INVENTION

This invention generally relates to the field of hand tools and more particularly, this invention relates to hand tools used for screwing and torquing.

### BACKGROUND OF THE INVENTION

Screw drivers have been around for a very long time, in one form or another. They are among the most useful and widely available tools in existence. They are essential to workmen, both professional and lay workers.

On occasion various screw drivers are used for excessively heavy torquing loads. In such cases, the handle of the screw driver in and of itself is insufficient to cause the desire torque on a screw. Often times, the user will continue to attempt to turn the screw, damaging either or both of the screw and the working end of the screw driver.

Thus what is needed is a tool which enables the user to apply more force on the screw driver to effectively turn such screws without damaging either the screw driver or the screw itself.

### SUMMARY OF THE INVENTION

An improved screw driver which includes structure for applying additional torquing force to the handle for turning a screw. In a first embodiment, the screw driver includes a torquing member and the screw driver having torquing member openings through which the member engages the screw driver.

It is an object of this invention to provide an improved screw driver which uses the basic structure of a conventional screw driver and adapts to engage a torquing member to provide additional torquing.

It is an additional object of this invention to provide a conventional screw driver having modifications to adapt to engaging a torquing member that do not change the basic characteristics of the screw driver and to provide an additional torquing member opposed handle for added torquing capability.

The structure in accordance with this invention, comprises:
an improved screw driver including a torquing member, comprising:
a screw driver having a handle and a working end, the working end adapted to turning screws, the handle having at least one torquing member opening,
adapted for engagement with the torquing member; and
a torquing member for engagement of the handle through the torquing member opening.

In another exemplary embodiment, the screw driver structure has a plurality of torquing member openings at different angles to the longitudinal axis of the screw driver. Different openings are used to apply different torques to the handle and hence the screw.

In another exemplary embodiment, the torquing member includes a second end and the second end includes a secondary handle and wherein the second end of the torquing member is adapted for connection with the secondary handle.

It will be appreciated that the second end gives the user the ability to apply even more torque to the screw driver of the instant invention without requiring the user to have additional strength. The user can apply substantially greater amounts of torque to the handle and consequently the screw being engaged by the working end of the screw driver.

It is an advantage of this invention to provide such an improved screw driver, which allows greater amounts of torque to be applied to the working end of a screw driver without changing the basic character of the screw driver.

It is an additional advantage of this invention to allow the user to apply torque at different angles.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is a perspective view of the screw driver member in accordance with this invention.

FIG. 2 is a perspective view of the screw driver member being engaged by the torquing member in accordance with this invention.

FIG. 3 is a perspective view of the screw driver member being engaged by the alternate embodiment of the torquing member in accordance with this invention.

### DETAILED DESCRIPTION OF THE INVENTION

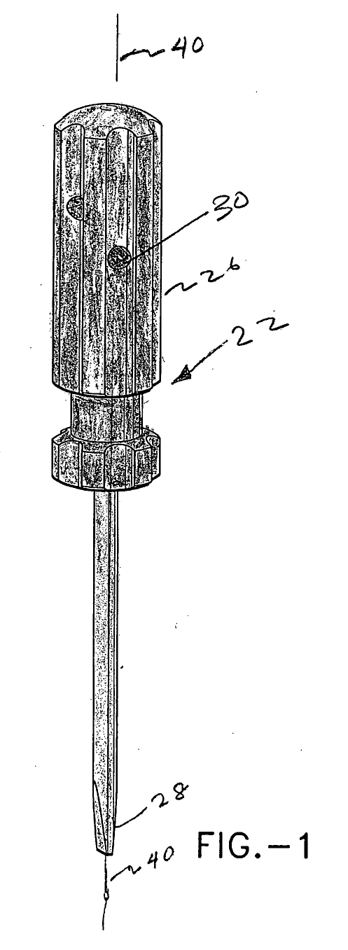

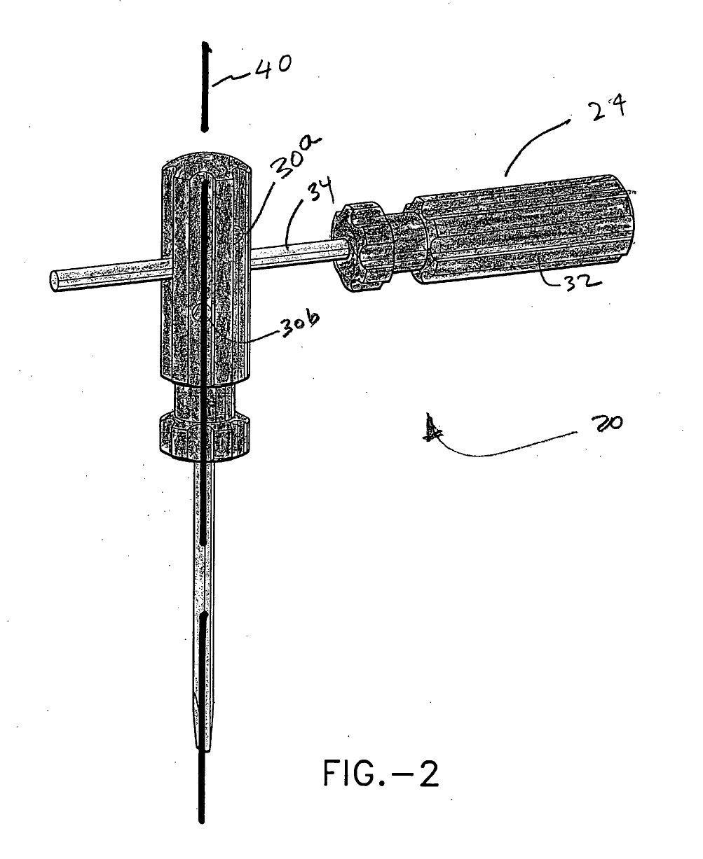

An exemplary embodiment of the improved screw driver in accordance with this invention generally denoted by the numeral 20 will now be described with reference to FIGS. 1-3. The improved screw driver 20 includes a screw driver member, also shown generally by the numeral 22 (FIG. 1) and a torquing member 24 (FIGS. 2 & 3). The screw driver member 22 has a handle end 26 and a working end 28. Additionally, the handle end 26 has at least one opening 30 designed to accommodate engagement with the torquing member 24.

The torquing member 24 has a first handle 32 and an elongated member 34. The elongated shaft member 34 is designed and adapted to fit smoothly through the opening 30. Upon being fit through the opening 30, the user can, when appropriate turn the screw driver member handle end 26 by appropriate movement of the torquing member 24.

As seen in FIGS. 2 & 3, the handle end 26 has additional openings 30a and 30b. Each of the openings is perpendicular to the longitudinal axis 40, but is located at a slightly different place on the handle, a different angle for the user to create the torque necessary to turn the screw driver handle end 26. However, as stated above, all the openings are perpendicular to the longitudinal axis 40 of the screw driver member in the exemplary embodiments. By having multiple openings, a user, in a tight spot, can torque the handle a limited amount, change opening with the torquing member 24 and then continue torquing the handle.

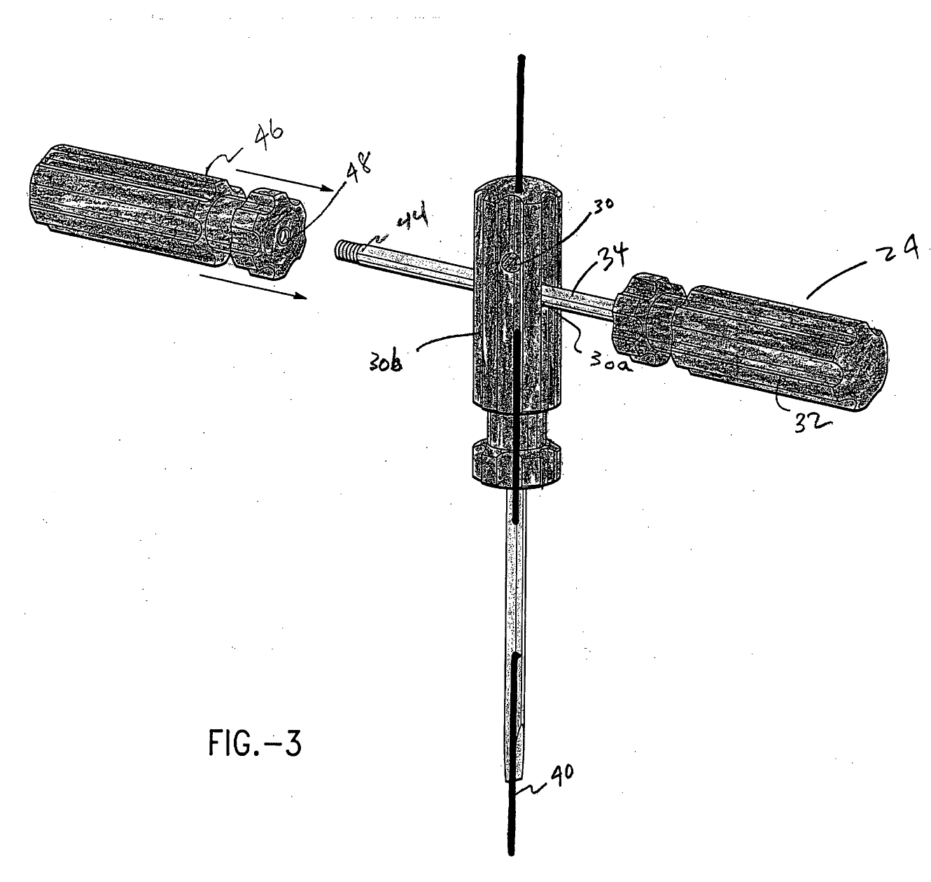

In the exemplary embodiment shown in FIG. 3, the torquing member 24 has a second end 44. Attached to the second end 44 is a secondary handle 46. In the embodiment shown, the secondary handle 46 has an internal opening 48 which is adapted to releaseably connect to the second end 44. For example, FIG. 3 illustrates the embodiment wherein the second end is a threaded end and the internal opening 48 in the secondary handle 46 is simply screwed into the second end 44. Of course, other exemplary embodiments are possible.

For example, within the spirit and scope of this invention, the second end 44 and the secondary handle 46 may be force fit or a Velcro fit may proved useful. The primary concern is that the secondary handle be fit for the purpose intended, namely to provide additional torquing force to the screw driver member 22 and to be releaseably connected thereto.

While the foregoing detailed description has described several embodiments of the improved screw driver in accordance with this invention, it is to be understood that the above description is illustrative only and not limiting of the disclosed invention. Particularly, there are numerous structures for adapting the secondary handle of the torquing member to the second end of the torquing member after the torquing member is engaging the screw driver member. Not all of these possibilities have been described above. Nevertheless, all are within the spirit and scope of the invention. Similarly, a number of openings may be provided in the handle of the screw driver member without affecting the integral structure of the member. Not all the holes or angles possible have been described above. Yet, as set forth above, all such variations are indeed within the spirit and scope of the invention of the improved screw driver herein. Thus, the invention is to be limited only by the claims as set forth below.

1. (canceled)

2. An improved screw driver including a torquing member, comprising:
a screw driver having a handle and a working end, the working end adapted to for turning screws, the handle having more than one torquing member opening, adapted for engagement with the torquing member; and
a torquing member for engagement of the handle through the torquing member opening.

3. The screw driver of claim 2, wherein the handle has a longitudinal axis, generally perpendicular to the axis of the each torquing member opening and wherein each of the openings is at a different angle to the longitudinal axis.

4. The screw driver of claim 1, wherein the torquing member has a first handle end, a elongated shaft and a second end.

5. The screw driver of claim 4, wherein the torquing member second end includes a secondary handle and wherein the second end of the torquing member is adapted for connection with the secondary handle for increased additional torquing force.

6. The screw driver of claim 1, wherein the handle has multiple torquing member openings.

7. An improved screw driver including member for creating additional torque, the improved screw driver comprising:
a screw driver having a handle and a working end, the working end adapted for turning screws, the handle having multiple torquing member openings, and
a torquing member for engagement of the handle through at least one of the torquing member openings,
whereby upon engagement of the torquing member with the handle the screw driver can do its job with additional torquing power and from more than one torquing positions.

8. The screw driver of claim 7, wherein the torquing member openings are at different angles to one another allowing the screw driver to be torqued from different positions.

9. The screw driver of claim 7, wherein the torquing member openings are at different and oblique angles to one another, allowing the screw driver to be torqued from different positions.
